(19) United States
(12) Patent Application Publication
(10) Pub. No.: US 2007/0075949 A1
(43) Pub. Date: Apr. 5, 2007

(54) Gray-scale driving method for bistable chiral nematic liquid crystal display

(75) Inventors: Chih Chiang Lu, Hsinchu County (TW); Chung Yi Chang, Hsinchu County (TW); Tai Ann Chen, Hsinchu County (TW); Chi Chang Liao, Hsinchu County (TW); Wei Ting Hsu, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/355,008

(22) Filed: Feb. 16, 2006

(30) Foreign Application Priority Data
Oct. 3, 2005 (TW) 94134480

(51) Int. Cl. G09G 3/36

(52) U.S. Cl. 345/89

(57) ABSTRACT

A gray-scale driving method for a bi-stable chiral nematic liquid crystal display is provided. The present method divides an updated picture into a first-section frame, a second-section frame and a third-section frame. The present invented method includes to drive the first-section frame into a predetermined initial state, and drive the second-section frame by line-by-line scanning by writing updated gray-scale frame data into the pixels, then pull the third-section frame to zero voltage for the pixels such that bi-stable chiral nematic liquid crystal relaxes to stable states corresponding to the write-in gray-scale frame data. Meanwhile, a purpose to maintain the updated picture without any consumption of power is obtained. The total power consumption can be significantly reduced.

### BACKGROUND OF THE INVENTION

1. Field of the Invention

The present invention relates to a gray-scale driving method for a bi-stable chiral nematic liquid crystal display; and more particularly to an active gray-scale driving method for a bi-stable chiral nematic liquid crystal display.

2. Description of the Related Art

Traditional bi-stable chiral nematic liquid crystal displays often use a passive multiplexing method for displays, and several different methods were developed to reach fast driving many years ago, examples of a dynamic driving method disclosed in U.S. Pat. No. 5,748,277 and a cumulative driving method disclosed in U.S. Pat. No. 6,204,835. However, because of the limitation to drive the passive matrix liquid crystal display, resolution, video, display quality and driving cost of the bi-stable chiral nematic liquid crystal display are not easy to be improved.

Philip uses a dynamic method to drive active matrix bi-stable chiral nematic liquid crystal display, but for attaining special waveforms, pixel design becomes much complicated. U.S. Pat. No. 6,703,995 of Philip using 5T1C pixel architecture requires many control signals to control transistors so as to increase cost of the driving system and complexity of the pixel design to cut down the yield, and has many transistors and capacitances to reduce aperture rate and degrades the display quality.

Additionally, U.S. Pat. No. 6,052,103 of Toshiba uses traditional design in the pixel architecture for the bi-stable chiral nematic liquid crystal display, and writes driving voltage waveforms with different states into pixel electrodes in an addressing period. But the transition time to drive each state is much longer than the electrode charging time to prolong the driving time, especially in case of the resolution of the display being increased, the driving time becomes too long to lose animation of a video, even degrades display quality of refreshing pages.

### SUMMARY OF THE INVENTION

According to the drawbacks mentioned above, it is one objective of the present invention to provide an active gray-scale driving method for a bi-stable chiral nematic liquid crystal display to curtail driving time of active matrix bi-stable chiral nematic liquid crystal display and improve resolution of display quality.

It is a further objective of the present invention to provide a gray-scale driving method for a bi-stable chiral nematic liquid crystal display use 1T1C architecture for pixel design to increase pixel aperture rate to improve display quality.

It is another objective of the present invention to provide a method of successively updating frames to reach an animation video.

According to the above objectives, the present invention provides a gray-scale driving method for a bi-stable chiral nematic liquid crystal display to divide an updated picture into a first-section frame, a second-section frame, and a third-section frame, including to drive the bi-stable chiral nematic liquid crystal into a predetermined initial state in the first-section frame; to write updated gray-scale data into pixels by line-by-line scanning in the second-section frame; to pull driving voltages of the pixels to zero to relax the bi-stable chiral nematic liquid crystal into stable states in correspondence to the gray-scale data.

During the period of driving the first-section frame, the bi-stable chiral nematic liquid crystal can be driven into the homeotropic state to erase the original picture, or into the focal conic state or the planar state to reach a predetermined initial state; and during the period of driving the second-section frame, the write-in voltage can be a combinational value of the focal conic state and planar state to display a gray-scale value, or a combinational value of the homeotropic state and focal conic state to preset the gray-scale value, Otherwise, after the second-section frame, a blank time can be added as a transition time to transform the homeotropic state into the planar state.

Furthermore, the present invention provides a successively updating frames method, and each updated picture is divided into a first-section frame, a second-section frame, and a third-section frame. The successively updating frames method includes to drive the bistable chiral nematic liquid crystal into a predetermined initial state in the first-section frame, to write updated gray-scale data into pixels by line-by-line scanning in the second-section frame; to pull driving voltages of the pixels to zero to relax the bi-stable chiral nematic liquid crystal into stable states in correspondence to the gray-scale data or not to change the driving voltages of the pixels such that the write-in data of the second-section frame relaxes to the corresponding stable states and preserves image display quality. The successively updating frames method includes driving in sequence the first-section frame, second-section frame, and the third-section frame for each updated picture until the last updated picture, and finally pulls driving voltages of the pixels to zero.

Preferably, during the period of the second-section frame of each updated picture, the write-in voltage is a combinational value of the planar state and focal conic state and called a gray-scale voltage.

### BRIEF DESCRIPTION OF THE DRAWINGS

FIG. 1 shows diagrammatically a driving circuit of the present invented bi-stable chiral nematic liquid crystal display;

FIG. 2A shows diagrammatically driving voltages of the pixels while driving each frame in the first embodiment of the present invention;

FIG. 2B shows diagrammatically driving voltages of the pixels while driving each frame in the second embodiment of the present invention;

FIG. 3 shows a r graph of a cholesterol liquid crystal used in the present invention;

FIG. 4 shows another r graph of a cholesterol liquid crystal used in the present invention;

FIG. 5 shows an electro-optical graph of a cholesterol liquid crystal used in the present invention;

FIG. 6A shows diagrammatically driving voltages of the pixels while driving each frame in the third embodiment of the present invention;

FIG. 6B shows diagrammatically driving voltages of the pixels while driving each frame in the fourth embodiment of the present invention;

FIG. 7A shows diagrammatically driving voltages of the pixels while driving each frame in the fifth embodiment of the present invention;

FIG. 7B shows diagrammatically driving voltages of the pixels while driving each frame in the sixth embodiment of the present invention;

FIG. 7C shows diagrammatically driving voltages of the pixels while driving each frame in the seventh embodiment of the present invention;

FIG. 8A shows diagrammatically driving voltages of the pixels while driving each frame in the eighth embodiment of the present invention;

FIG. 8B shows diagrammatically driving voltages of the pixels while driving each frame in the ninth embodiment of the present invention; and

FIG. 9 shows another electro-optical graph of a cholesterol liquid crystal used in the present invention.

### DETAILED DESCRIPTION OF THE PREFERRED EMBODIMENTS

The bi-stable chiral nematic liquid crystal display of the present invention includes a plurality of pixel electrodes formed as an active matrix, a common electrode facing to the pixel electrodes and a display medium layer such as bi-stable chiral nematic liquid crystal layer interposed between the pixel electrodes and the common electrode. The pixel electrodes, the display medium layer and the common electrode constitute a plurality of pixel capacitors, and a plurality of switches is connected to the corresponding pixel electrode to drive the corresponding pixel electrode. In the present invention, each pixel has an ability to include a store capacitor to stabilize the pixel voltage. While writing data into pixel electrodes, the pixel capacitors and store capacitors are charged/discharged to maintain the potential of write-in data, and the electrical fields of the pixel capacitors are used to drive the display medium to modulate light to display the information.

More definitely, the bi-stable chiral nematic liquid crystal display of the present invention designs the pixel to an architecture of 1T1C, 1T is the most essential active element for a traditional active matrix liquid crystal display and functioning as the switch for addressing or non-addressing, and 1C is the common-used passive element for a traditional active matrix liquid crystal display, like store capacitor, to stabilize and adjust the capacitance of the pixel to reduce the shift of pixel voltage.

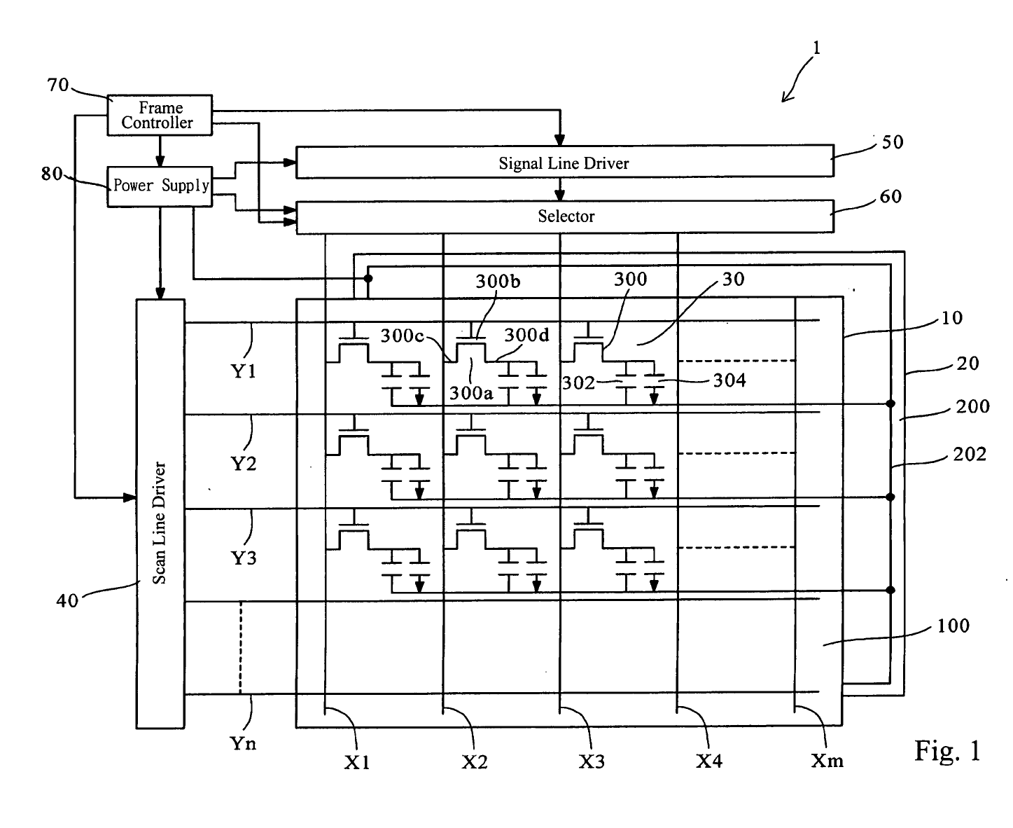

FIG. 1 shows diagrammatically a driving circuit of the present invented bi-stable chiral nematic liquid crystal display. Referring to FIG. 1, the bi-stable chiral nematic liquid crystal display 1 of the present invention includes a first board 10, a second board 20, a bi-stable chiral nematic liquid crystal medium layer (not shown), a plurality of row electrodes (not shown), a plurality of column electrodes (not shown), a common electrode 202, a plurality of scan lines Y₁, Y₂, Y₃, . . . , Yₙ, a plurality of signal lines X₁, X₂, X₃, . . . , Xₘ, a plurality of switch components 300, a plurality of capacitor components 304, a scan line driver 40, a signal line driver 50, a selector 60, a frame controller 70 and a power supply 80. The first board 10 includes a first major surface 100, the row electrodes and column electrodes are formed on the first major surface 100 in a matrix. The second board 20 includes a second major surface 200 opposite to the first major surface 100, and the common electrode 202 is formed on the second major surface 200 to correspond to the row electrodes and column electrodes. The bi-stable chiral nematic liquid crystal medium layer, e.g. the cholesterol liquid crystal medium layer, is interposed between the first board 10 and the second board 20, the liquid crystal medium layer corresponding to an intersection of each row electrode and each column electrode constitutes a pixel 30, and the pixel 30 forms a pixel capacitor 302 which has an terminal to connect to the common electrode 202 and another terminal to form a pixel electrode. The scanning line Y₁, Y₂, Y₃, . . . , Yₙ and the signal lines X₁, X₂, X₃, . . . , Xₘ are formed on the first major surface 100 in a matrix, each scan line corresponds to a row of the row electrodes, and each signal line corresponds to a column of the column electrodes. Each switch component 300, e.g. a transistor, is formed on an intersection of each row electrode and each column electrode, to be a driving switch for the corresponding pixel 30. The switch component 300 has a conductive channel 300a and a control terminal 300b to control conduction of the conductive channel 300a . The control terminal 300b is connected to a corresponding scan line. The conductive channel 300a has a first terminal 300c and a second terminal 300d, of which the first terminal 300c is connected to a corresponding signal line and the second terminal 300d is connected to a corresponding pixel electrode. The capacitor components 304 are formed on the first major surface 100 and each of which corresponds to one of the pixels 30. The capacitor component 304 has an terminal to connect to a corresponding pixel electrode and another terminal to connect to the ground or to a positive or negative voltage. The other terminal of the capacitor component 304 can be short to the common electrode 202 to connect to a negative voltage to cut down the system highest voltage, and reduces a suffering voltage of the switch component 300, e.g. the transistor, in the pixel 30 to preserve the characteristic stability of the transistor. The capacitor component 304 is used to stabilize and adjust the capacitance of the corresponding pixel 30 to reduce the shift of the pixel voltage. The scan line driver 40 provides at least a scan signal to each scan line, and the signal line driver 50 provides at least a data signal to each signal line. The selector 60 connects to the output terminal of the signal line driver 50 and the power supply 80 to be a voltage input, and connects to the signal line X₁, X₂, X₃, . . . , Xₘ to be a voltage output. The selector 60 chooses the input voltage between the power supply 80 and the signal line driver 50 by a control signal input received from a control pin (not shown), and conducts the input voltage to the signal line X₁, X₂, X₃, . . . , Xₘ. The control signal of the control pin from the selector 60 is provided from the frame controller 70. The power supply 80 provides individual voltage to the scan line driver 40, the signal line driver 50, the selector 60 and the common electrode 202. The frame controller 70 stores the frame data and processes it, and controls the signal line driver 50 to output voltage signal. The frame controller 70 also controls the scan line driver 40 to output scan signal, and controls the power supply 80 to output various voltages to control the driving voltage for each pixel.

The gray-scale driving method for the bi-stable chiral nematic liquid crystal display of the present invention includes to drive the first-section frame into a predetermined initial state; to write updated gray-scale data into pixels by line-by-line scanning in the second-section frame; to pull driving voltages of the pixels to zero to relax the bi-stable chiral nematic liquid crystal into stable states in correspondence to the gray-scale data During the period of driving the first-section frame, the bi-stable chiral nematic liquid crystal can be driven into the homeotropic state to erase the original picture, or driven into the focal conic state or a planar state to reach a predetermined initial state. When the predetermined initial state is set to the planar state, the bi-stable chiral nematic liquid crystal is first driven into the homeotropic state then relaxed to the planar state, and then a front blank time can follow the first-section frame as a relaxation time to transfer the homeotropic state to the planar state. During the period of driving the second-section frame, the write-in voltage can be a combinational value of the focal conic state and the planar state to display a gray-scale value, or a combinational value of the homeotropic state and the focal conic state to preset the gray-scale value, after the second-section frame, a blank time can be added as a transition time for transforming the homeotropic state to the planar state. The write-in voltage in the period of driving the second-section frame corresponds to the updated gray-scale frame data. The required voltage of the display panel in the third-section frame period pulls to zero and all pixels reset to zero accordingly, so as to reduce the power consumption of the display panel to zero. After the third-section frame is booted, the bi-stable chiral nematic liquid crystal will recover to the stable state corresponding to the write-in data in the second-section frame due to bi-stable chiral nematic liquid crystal itself characteristics. Therefore, the driving voltages of the pixels in the first-section frame and the third-section frame are individual fixed voltages and are supplied from the power supply 80. The driving voltages of the pixels in the second-section frame correspond to the write-in gray-scale frame data and are supplied from the signal line driver 50. In another words, the data voltages in the first-section frame, the second-section frame and the third-section frame are chosen by the selector 60. Some drivers can output individual fixed voltages simultaneously and reach the same driving result without the selector 60.

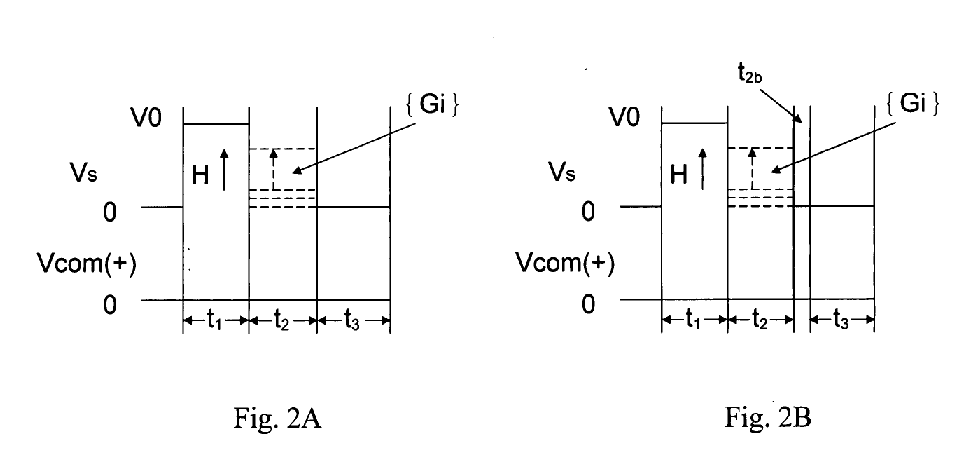

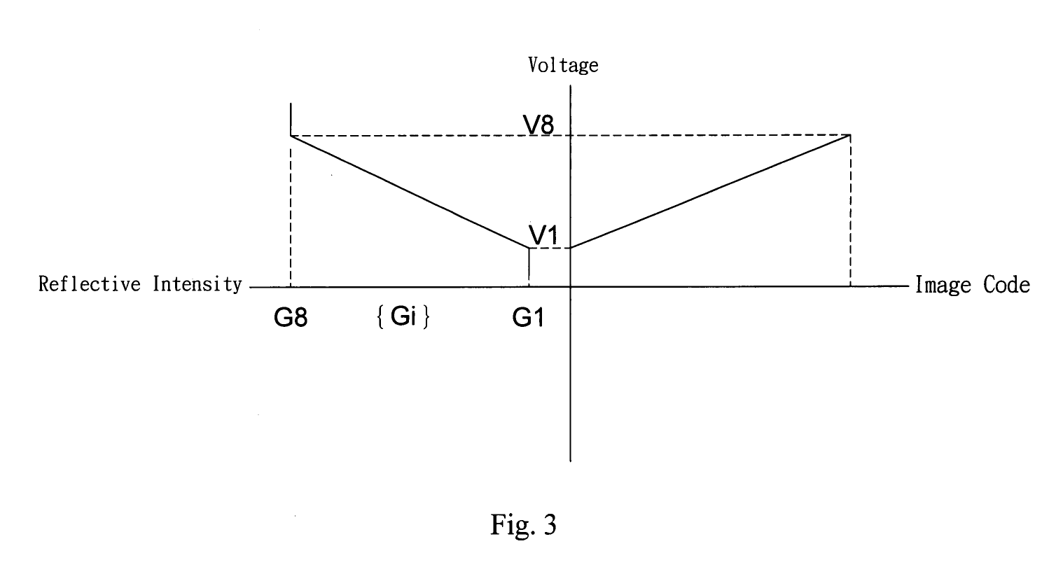

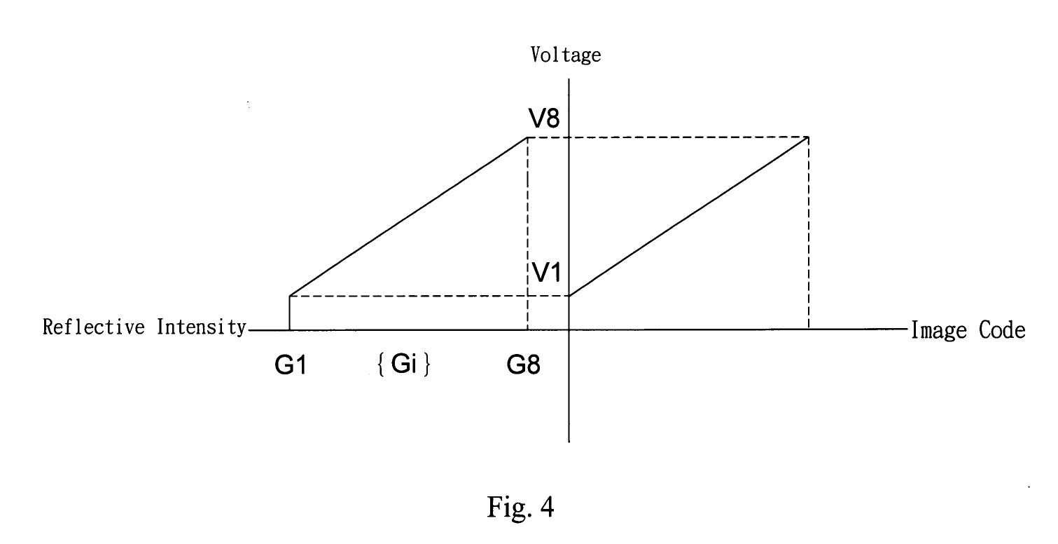

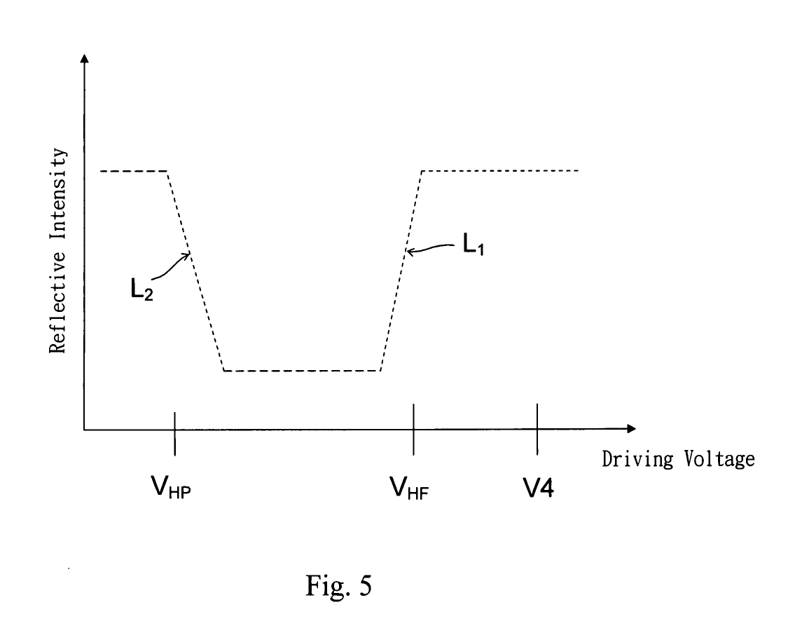

FIG. 2A shows diagrammatically the driving voltages of the pixels in the first-section frame, the second-section frame and the third-section frame of the present gray-scale driving method for the bi-stable chiral nematic liquid crystal display according to the first embodiment of the present invention. In the first-section frame time, the bi-stable chiral nematic liquid crystal is set to the homeotropic state to clean memory data inside pixel to erase the original picture. In the second-section frame period, the updated gray-scale frame data is written into the pixel by line-by-line scanning in order to drive the bi-stable chiral nematic liquid crystal to a combinational state of the planar state and the focal conic state corresponding to the gray-scale frame data. During the period of the second-section frame, the bi-stable chiral nematic liquid crystal is driven to a specific combinational state of the planar state and the focal conic state by a hysteresis to display a predetermined gray-scale value {Gi}. For example, the hysteresis revealed in slope L₁ of FIG. 5 can be used to drive the cholesterol liquid crystal to a combinational state of the planar state and the focal conic state corresponding to the predetermined gray-scale value. FIG. 3 shows a r graph corresponding to the slope L₁ of FIG. 5, the left side of FIG. 3 shows a relationship between various gray-scale values (G1,G2, . . . , G3) and the pixel driving voltages, and the right side of FIG. 3 shows a relationship between the pixel driving voltages and image codes. In other words, the write-in data of the second-section frame can include a plurality of bits (plural codes) to correspond to the combinational state of the planar state and the focal conic state. Besides, the hysteresis revealed in slope L₂ of FIG. 5 can be used to drive the cholesterol liquid crystal to a combinational state of the planar state and the focal conic state corresponding to a predetermined gray-scale value. FIG. 4 shows a γ graph corresponding to the slope L₂ of FIG. 5, the left side of FIG. 4 shows a relationship between various gray-scale values (G1,G2, . . . ,G3) and the pixel driving voltages, and the right side of FIG. 4 shows a relationship between the pixel driving voltages and image codes. During the period of the third-section frame, the driving voltages of the pixels are reset to zero, meanwhile, the bi-stable chiral nematic liquid crystal will relax to a combinational state of the planar state and the focal conic state corresponding to the write-in gray-scale frame data due to itself characteristics. During the third-section frame, the driving voltages of the pixels can be set to zero simultaneously or by line-by-line scanning, hence, the display preserves the voltage to zero and prevent the display panel consuming power after frames refresh.

FIG. 2B shows diagrammatically driving voltages of the pixels while driving each frame in the second embodiment of the present invention. The difference between the first embodiment and second embodiment is that in the second embodiment after the second-section frame followed by a blank time t_{2b} as a transition time for transforming the bi-stable chiral nematic liquid crystal to a combinational state of the planar state and the focal conic state corresponding to the write-in gray-scale value {Gi}.

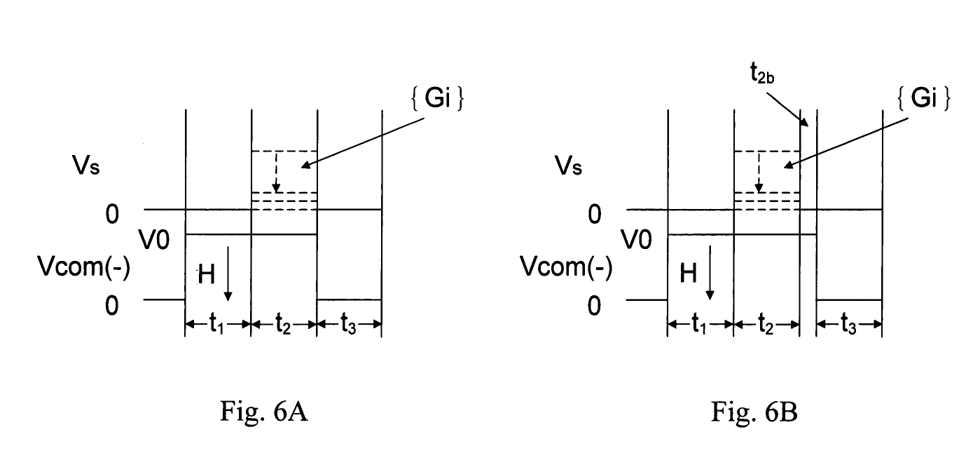

Furthermore, the gray-scale driving method for the bi-stable chiral nematic liquid crystal display of the present invention includes a polarity reversing function to maintain stability of the bi-stable chiral nematic liquid crystal. FIG. 6A shows diagrammatically driving voltages of the pixels while driving each frame in the third embodiment of the present invention. During the period of the first-section frame, the driving voltage of the common electrode 202 (Vcom(−)) is H, and the driving voltages of the pixel electrodes are zero, so that the driving voltages of the pixels are −H, and that is, the bi-stable chiral nematic liquid crystal is driven to the homeotropic state simultaneously. During the period of the second-section frame, the bi-stable chiral nematic liquid crystal is driven to a specific combinational state of the planar state and the focal conic state by a hysteresis revealed in the slope L₁ of FIG. 5 to display the predetermined gray-scale value {Gi}. According to the y graph of FIG. 3, the gray-scale values G1, G2, G3, . . . , G1, . . . , G8 respectively correspond to the pixel driving voltages V1, V2, V3, . . . , V1, . . . , V8, also the pixel driving voltages have a linear relationship Vi=V1+(i−1)ΔV, and the corresponding reversing voltages have a linear relationship {Vi*}=V0−{Vi}, if V0=V1+V8 then V1*=V8, V2*=V7, V3*=V6, . . . , V8*=V1. Therefore, a pixel driving voltages {V1, V2, V3, V4, V5, V6, V7, V8} similar to FIG. 2A can be used while executing the polarity reversing function. If V0=V8, then V1*=V8-V1, . . . , V8*=V8−V8=0, and also in order to execute the polarity reversing function, it needs to use another set of pixel driving voltages and the lowest voltage can be drop to zero. Besides, the bi-stable chiral nematic liquid crystal also can be driven to a specific combinational state of the planar state and the focal conic state by a hysteresis revealed in the slope L₂ of FIG. 5 to display the predetermined gray-scale value {Gi}. According to the γ graph of FIG. 3, the gray-scale values G1, G2, G3, . . . , Gi, . . . , G8 correspond to the pixel driving voltages V1, V2, V3, . . . , Vi, . . . , V8, also the pixel driving voltages have a linear relationship Vi=V1+(i−1)ΔV, and the corresponding reversing voltages have a linear relationship {Vi*}=V0−{Vi}, if V0=V1+V8 then V1*=V8, V2*=V7, V3*=V6, . . . , V8*=V1. Therefore, a set of pixel driving voltages {V1, V2, V3, V4, V5, V6, V7, V8} similar to FIG. 2A can be used while executing the polarity reversing function. If V0=V8, then V1*=V8−V1, . . . , V8*=V8−V8=0, and also in order to execute the polarity reversing function, it needs to use another set of the pixel driving voltages and the lowest voltage can be drop to zero. During the period of the third-section frame, the driving voltages of the pixels are set to zero simultaneously or by line-by-line scanning to relax the bi-stable chiral nematic liquid crystal to a stable state corresponding to the write-in gray-scale value in the second-section frame.

FIG. 6B shows diagrammatically pixel driving voltages while driving each frame in the fourth embodiment of the present invention. The difference between the third embodiment and fourth embodiment is that in the fourth embodiment after the second-section frame followed by a blank time t_{2b} as a transition time for transforming the bi-stable chiral nematic liquid crystal into a combinational state of the planar state and the focal conic state corresponding to the write-in gray-scale value.

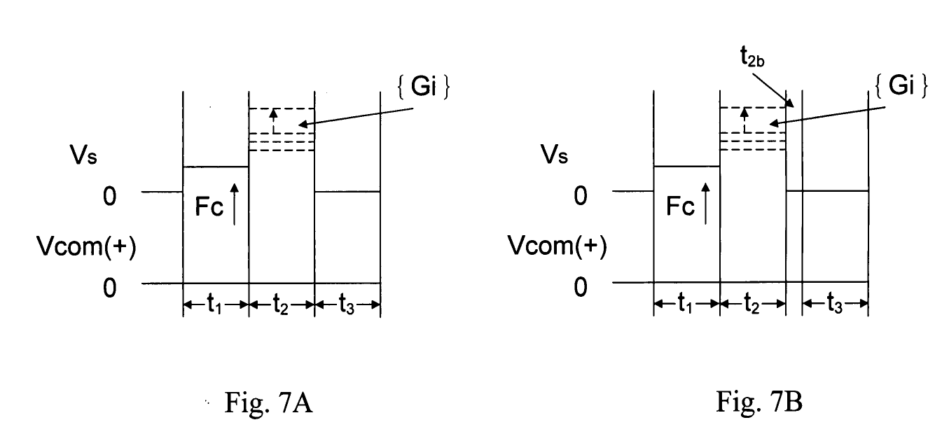

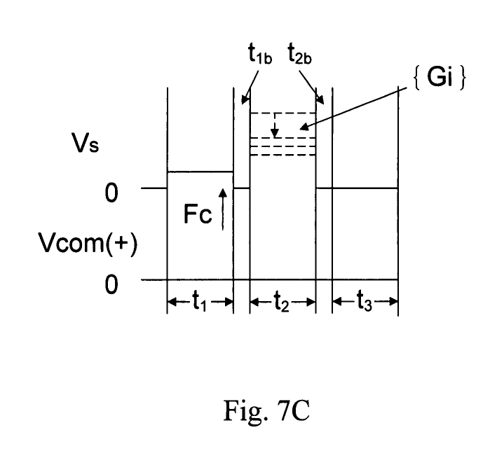

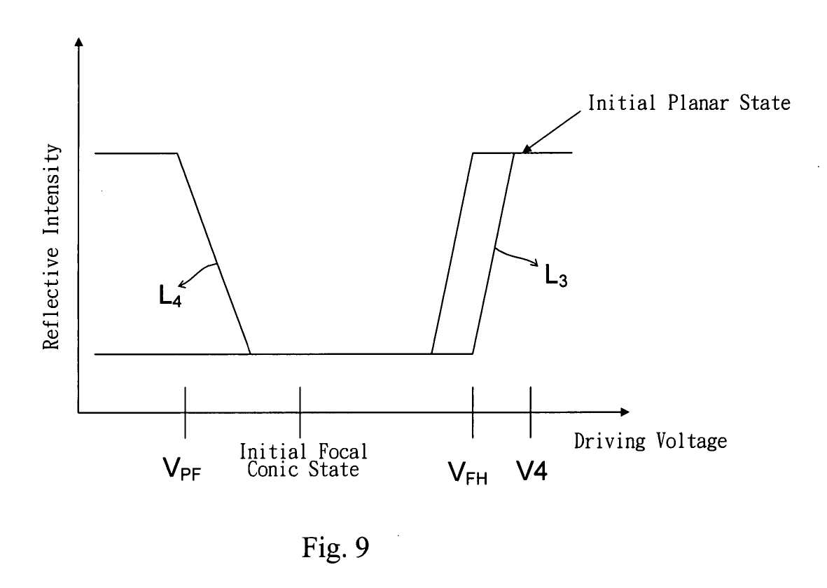

FIG. 7A shows diagrammatically driving voltages of the pixels while driving each frame in the fifth embodiment of the present invention. During the period of the first-section frame, the bi-stable chiral nematic liquid crystal is driven to the focal conic state simultaneously or by line-by-line scanning to be a predetermined initial state. During the period of the second-section frame, the bi-stable chiral nematic liquid crystal is driven to a specific combinational state of the homeotropic state and the focal conic state by an electro-optical characteristic revealed in the slope L₃ of FIG. 9 to display the corresponding gray-scale value. In other words, during the period of the second-section frame, the bi-stable chiral nematic liquid crystal is driven by the liquid crystal electro-optical characteristic revealed in the slope L₃ of FIG. 9 in a line-by-line scanning way. During the period of the third-section frame, the driving voltages of the pixels are set to zero simultaneously or by line-by-line scanning. FIG. 7B shows diagrammatically pixel driving voltages while driving each frame in the sixth embodiment of the present invention. The difference between the sixth embodiment and fifth embodiment is that in the sixth embodiment after the second-section frame followed by a blank time t_{2b} as a transition time for transforming the bi-stable chiral nematic liquid crystal to a combinational state of the homeotropic state and the focal conic state corresponding to the write-in gray-scale value {Gi}.

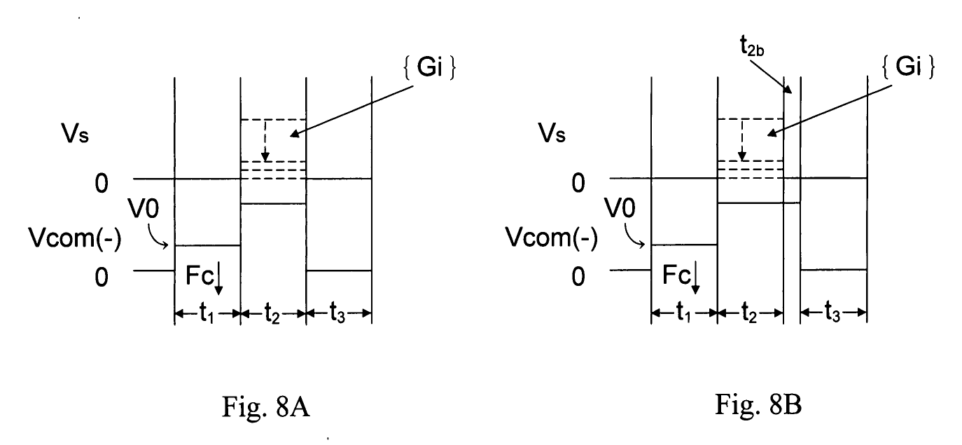

FIG. 7C shows diagrammatically pixel driving voltages while driving each frame in the seventh embodiment of the present invention. During the period of the first-section frame, the bi-stable chiral nematic liquid crystal is driven to the focal conic state simultaneously and followed by a front blank time t_{1b} as a transition time for transforming the bi-stable chiral nematic liquid crystal to the focal conic state. During the period of the second-section frame, the bi-stable chiral nematic liquid crystal is driven to a specific combinational state of the homeotropic state and the focal state by the liquid crystal electro-optical characteristic revealed in the slope L₃ of FIG. 9 to display the corresponding gray-scale value. In other words, during the period of the second-section frame, the bi-stable chiral nematic liquid crystal is driven by line-by-line scanning and the liquid crystal electro-optical characteristic revealed in the slope L₃ of FIG. 9. During the period of the second-section frame, a rear blank time follows the second-section frame as a transition time for transforming the bi-stable chiral nematic liquid crystal to the combinational state of the homeotropic state and the focal conic state. During the period of the third-section frame, the driving voltages of the pixels are set to zero simultaneously or by line-by-line scanning. FIG. 8A shows diagrammatically driving voltages of the pixels while driving each frame in the eighth embodiment of the present invention. In the eighth embodiment, the present invention provides a polarity reversing function, during the period of the first-section frame, making the Vcom(−) voltage from the common electrode 202 as Fc and the driving voltages from the pixel electrodes as zero to set the driving voltages of the pixels as −Fc. In other words, during the period of the first-section frame, the bi-stable chiral nematic liquid crystal is driven to the focal conic state simultaneously or by line-by-line scanning. During the period of the second-section frame, the bi-stable chiral nematic liquid crystal is driven to a specific combinational state of the planar state and the focal conic state by line-by-line scanning to display the corresponding gray-scale value {Gi}. During the period of the third-section frame, the driving voltages of the pixels are set to zero simultaneously or by line-by-line scanning. FIG. 8B shows diagrammatically driving voltages of the pixels while driving each frame in the ninth embodiment of the present invention. In the ninth embodiment, the present invention provides a reversing function, the difference between the ninth embodiment and eighth embodiment is that in the ninth embodiment after the second-section frame follows a blank time as a transition time for transforming the bi-stable chiral nematic liquid crystal to the combinational state of the planar state and the focal conic state corresponding to the aforesaid gray-scale value {Gi}.

Furthermore, the present invention provides a successively updating frames method, and each of the updated picture is divided into a first-section frame, a second-section frame, and a third-section frame. The present invention includes to drive the bi-stable chiral nematic liquid crystal into a predetermined initial state in the first-section frame; to write updated gray-scale data into pixels by line-by-line scanning in the second-section frame; to pull driving voltages of the pixels to zero to relax the bi-stable chiral nematic liquid crystal into stable states in correspondence to the gray-scale data, or not to change the driving voltages of the pixels such that the write-in data of the second-section frame relaxes to the corresponding stable states and preserves image display quality. The successively updating frames method includes to drive the first-section frame, the second-section frame and the third-section frame of each updated picture until the last updated picture, and then zero down the driving voltages of the pixels. According to the present invention, a purpose for updating animation video can be reached by means of the successively updating frames method.

While the invention has been described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

What is claimed is:

1. A gray-scale driving method for a bi-stable chiral nematic liquid crystal display, dividing an updated picture into a first-section frame, a second-section frame and a third-section frame, comprising:
driving said first-section frame by driving bi-stable chiral nematic liquid crystal into a predetermined initial state;
driving said second-section frame by writing updated gray-scale frame data into the pixels by line-by-line scanning; and
driving said third-section frame to zero voltage for the pixels such that the bi-stable chiral nematic liquid crystal relaxes to stable states corresponding to the write-in gray-scale data.

2. The gray-scale driving method as claimed in claim 1, wherein a blank time follows the second-section frame, the blank time is functioning as a driving buffer time for sufficiently transforming the bi-stable chiral nematic liquid crystal to the stable states corresponding to the write-in gray-scale frame data.

3. The gray-scale driving method as claimed in claim 1, wherein the step for driving the first-section frame resets the bi-stable chiral nematic liquid crystal simultaneously to a homeotropic state to clean the data memorized in the pixels.

4. The gray-scale driving method as claimed in claim 1, wherein the step for driving the first-section frame drives the bi-stable chiral nematic liquid crystal to a focal conic state as a predetermined initial state.

5. The gray-scale driving method as claimed in claim 4, wherein the step for driving the first-section frame drives the bi-stable chiral nematic liquid crystal simultaneously to a focal conic state.

6. The gray-scale driving method as claimed in claim 4, wherein the step for driving the first-section frame drives the bi-stable chiral nematic liquid crystal to a focal conic state by line-by-line scanning.

7. The gray-scale driving method as claimed in claim 1, wherein the step for driving the first-section frame drives the bi-stable chiral nematic liquid crystal to a planar state as a predetermined initial state.

8. The gray-scale driving method as claimed in claim 1, wherein the write-in data in the second-section frame includes at least one bit corresponding to a combination of the planar state and focal conic state.

9. The gray-scale driving method as claimed in claim 1, wherein the output voltage of the second-section frame corresponds to a combination of the planar state and focal conic state.

10. The gray-scale driving method as claimed in claim 1, wherein the third-section frame resets the driving voltages of the pixels to zero simultaneously.

11. The gray-scale driving method as claimed in claim 1, wherein the third-section frame resets the driving voltages of the pixels to zero by line-by-line scanning.

12. The gray-scale driving method as claimed in claim 1, wherein said driving method includes reversing function by changing driving voltages.

13. The gray-scale driving method as claimed in claim 1, wherein said driving method includes reversing function by reversing codes.

14. A successively updating frames method, dividing an updated picture into a first-section frame, a second-section frame and a third-section frame, wherein said first-section frame is to drive bi-stable chiral nematic liquid crystal into a predetermined initial state; driving said second-section frame by writing updated gray-scale frame data into the pixels by line-by-line scanning; and driving said third-section frame to zero voltage for the pixels such that the bi-stable chiral nematic liquid crystal relaxes to stable states corresponding to the write-in gray-scale data; the successively updating frames method comprising:
driving the first-section frame, the second-section frame and the third-section frame of each updated picture sequentially till the last updated picture which drives the first-section frame, the second-section frame and the third-section frame and then sets the driving voltages of the pixels to zero.

15. A successively updating frames method, dividing an updated picture into a first-section frame, a second-section frame and a third-section frame, wherein said first-section frame is to drive bi-stable chiral nematic liquid crystal into a predetermined initial state; driving said second-section frame by writing updated gray-scale frame data into the pixels by line-by-line scanning; and driving said third-section frame by not changing the voltages of the pixels such that the write-in data of said second-section frame relaxes to corresponding stable states and preserves image display quality; the successively updating frames method comprising: driving said first-section frame, said second-section frame and said third-section frame of each updated picture sequentially till the last updated picture,which drives said first-section frame, said second-section frame and said third-section frame and then sets the driving voltages of the pixels to zero.
